(19) United States
(12) Patent Application Publication
(10) Pub. No.: US 2005/0193619 A1
(43) Pub. Date: Sep. 8, 2005

(54) In-line fishing spinner

(76) Inventor: Jerry Bechhold, Petaluma, CA (US)

Correspondence Address: JOHNSON & STAINBROOK, LLP, 3558 ROUND BARN BLVD., SUITE 203, SANTA ROSA, CA, 95403, US

(21) Appl. No.: 11/072,903

(22) Filed: Mar. 4, 2005

Related U.S. Application Data
(60) Provisional application No. 60/550,500, filed on Mar. 4, 2004.

(51) Int. Cl. A01K 85/00

(52) U.S. Cl. 43/42.16

(57) ABSTRACT

An improved in-line fishing spinner having a simulated fish head with opposing angled fins which induce a spinning action when the apparatus is dragged through water. The head includes a nose having an opening through which a line or leader is inserted, the line being connected behind the nose to a hook concealed in a filamentous tail and in front of the nose to a spinning device.

### CROSS REFERENCE TO RELATED APPLICATIONS

The present application claims the benefit of the filing date of U.S. Provisional Patent application Ser. No. 60/550,500, filed Mar. 4, 2004 (Mar. 4, 2004).

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to fishing lures, and more particularly to a lure having a spinner with a rotating imitation fish head having fins, which eliminates the need for a conventional spinner blade and clevis.

### BACKGROUND INFORMATION AND DISCUSSION OF RELATED ART

The field of fishing lures is crowded with countless creative solutions to the numerous problems anglers have encountered in the field. The general philosophy underlying lure design is to provide a device that closely mimics the most attractive prey for the sought-after predatory species of fish. To that end, lures have been designed to mimic both the movements and the appearance of bait fish. In some instances, successful lures, while not imitating food in the field, have mysteriously attracted fish for reasons that cannot be ascertained and evidently have nothing to do with technology imitating nature. In fact, successful lures need not closely imitate aquatic or insect life. It is known that shiny metallic objects with certain spinning movements will elicit a strike response in fish. One such lure is the well-known spinning lure, of which there are countless iterations. Illustrative of the spinning lures is U.S. Pat. No. 6,108,961 to Milawski, et al, issued Aug. 29, 2000. This patent discloses a twisted, spinning fishing lure and counterweight that comprises a proximal end, a distal end, a counterbalance arm, and a rotatable helical body element having a lumen passing entirely through the body and a wire extending through the lumen. The wire includes a proximal portion having a eyelet for attaching to a fishing line and a counterbalance arm extending distally from the eyelet. Bearings reduce rotational forces from being transmitted from the rotatable helical body element to the wire extending through the body lumen. Any rotation forces transmitted to the wire are purportedly opposed by the counterbalance arm. The design provides for a pure spinning motion of the helical spinner body when dragged underwater.

U.S. Pat. No. 6,112,450 to Studanski, issued Sep. 5, 2000, discloses a zigzag aquatic device tethered by a single line that provides an accentuated zigzag or oscillating movement when the device has a relative speed with respect to water.

U.S. Pat. No. 6,115,957 to Bocach, issued Sep. 12, 2000, teaches a fishing lure including a body member having a wing member coupled to the body member with one of the ends of the wing member outwardly extending from one of the sides of the body member and the other end of the wing member outwardly extending from the other side of the body member. The second end of an elongate front flexible member is coupled to the front of the body member while the second end of an elongate rear member is detachably attached to the back of the body member.

U.S. Pat. No. 6,243,982 to Halterman, Jr. Jun. 12, 2001, discloses a spinner for spinning lures formed to resemble a small bait fish which rotates in moving air or water as a result of action against the broad surfaces of the tail fin plates and the internal broad surfaces of the spinner bodies.

Numerous fishing tackle manufacturers currently offer pull bait and jerk bait Mepps-type, blade bait lures that employ rotating blades. Occasionally spinners are equipped with an in-line blade or propeller-type spinning blade that eliminates the need to use a clevis to allow free spinning of the blade. In either case, the blades are mounted on a bead, bearing, or central shaft that spins freely on leader immediately in front of the hook. The hook is frequently disguised within some type of tail at the end of the lure body.

While the foregoing patents and products reflect the current state of the art of which the present inventor is aware, it is respectfully submitted that none disclose, teach, suggest, or otherwise render obvious the lure apparatus of the present invention, either when considered singly or in combination. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention is an improved in-line fishing spinner having a simulated fish head with opposing angled fins which induce a rapid and attractive spinning action when the apparatus is dragged through water. The head includes a nose having an opening through which a line is inserted, said line connected behind the nose to a hook concealed in a filamentous tail and in front of the nose to a spinning device.

It is an object of the present invention to provide a new and improved fishing spinner having a substantially symmetrical spinning pattern that mimics indigenous fish populations.

It is another object of the present invention to provide a new and improved in-line fishing spinner that has opposing fins that induce a spinning motion.

A further object or feature of the present invention is to provide a new and improved fishing spinner having a filament tail that conceals a hook and optional bait while in use.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of the improved in-line fishing spinner of the present invention;

FIG. 2 is a left side view in elevation thereof; and

FIG. 3 is a right side view in elevation thereof.

### DRAWING REFERENCE NUMERALS

100 apparatus generally
110 simulated fish head
120 nose portion
130 gill portion
140 pair of eyes
150 first fin
150a level section of first fin
150b upward turning section of first fin
160 second fin
160a level section of second fin
160b downward turning section of second fin
L longitudinal axis of apparatus
170 nose
180 opening in nose
190 tail portion
200 filaments

### DETAILED DESCRIPTION OF THE INVENTION

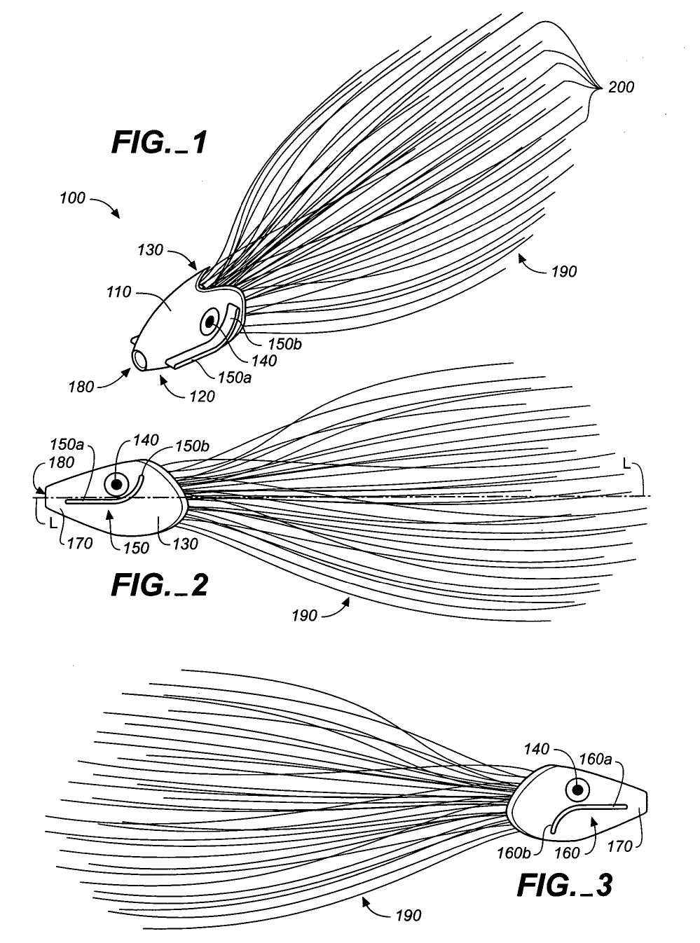

Referring to FIGS. 1 through 3, wherein like reference numerals refer to like components in the various views, there is illustrated therein a new and improved in-line fishing spinner, generally denominated 100 herein. FIG. 1 illustrates a first preferred embodiment of the inventive apparatus, which comprises a simulated fish head 110 having a nose portion 120, a gill portion 130, a pair of eyes 140, and first and second fins, 150, 160, disposed along opposite sides of the head immediately below the eyes and generally from the nose portion of the head to the gill portion of the head. The fins are preferably integral with, and normal to, the side of the head. Each fin preferably includes a level section 150a, 160a, disposed substantially parallel to the longitudinal axis L of the spinner. Additionally, however, the first fin 150 includes an upward angling section 150b that turns upwardly from the nose to the gill portion, and the second fin 160 includes a downward angling section 160b that turns downwardly from the nose to the gill portion. The angling aspects of the fins can comprise a simple angling of the fin, or they may comprise curved or arcuate sections. In either case, the angling aspect induces a spinning motion of the entire apparatus as it is dragged through water.

The nose 170 includes an opening 180 through which a fishing line or wire leader is inserted, so that a hook may be embedded behind the gill portion within a tail portion 190. The tail portion comprises a plurality of filaments 200 that conceal the hook, mimic colors and movement patterns of indigenous fish species, and create a turbulent wake behind the dragging and spinning apparatus. In use, it is preferable that the present invention be connected to an in-line spinning assembly in front of the nose. Such a device is not shown in the drawings but is well known in the art. This permits one-way spinning over extended periods without compromising line integrity. The assembly configuration also permits in-line spinning such that the general spin pattern is substantially symmetrical and circular.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. An in-line fishing spinner, comprising:
a simulated fish head having a nose portion, a gill portion, a pair of eyes, and a longitudinal axis;
first and second fins disposed on opposite sides of said head; and
a filamentous tail disposed immediately behind said gill portion of said head.

2. The apparatus of claim 1, wherein said first fin is disposed below one of said eyes and said second fin is disposed below the other of said eyes.

3. The apparatus of claim 1, wherein said first and said second fin extend generally from said nose portion of said head to said gill portion of said head.

4. The apparatus of claim 1, wherein each of said first and second fins are integral with, and normal to, a side of said head.

5. The apparatus of claim 1, wherein each of said first and second fins includes a level section disposed substantially parallel to said longitudinal axis L

6. The apparatus of claim 5, wherein said first fin includes an upward angling section, and said second fin includes a downward angling section.

7. The apparatus of claim 6, wherein said upward angling section of said first fin turns upwardly in a curved section and said downward angling section of said second fin turn downwardly in a curved section.

8. The apparatus of claim 1, further including a nose having an opening through which a fishing line may be inserted for attachment to a hook disposed in said filamentous tail.
